(19) United States
(12) Patent Application Publication
(10) Pub. No.: US 2010/0333212 A1
(43) Pub. Date: Dec. 30, 2010

(54) PORTABLE PARAMETER-BASED LICENSING

(75) Inventors: Todd L. Carpenter, Monroe, WA (US); David Abzarian, Kirkland, WA (US); David J. Foster, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/491,280

(22) Filed: Jun. 25, 2009

(51) Int. Cl. G06F 21/00; H04L 9/32

(52) U.S. Cl. 726/29; 713/185

(57) ABSTRACT

Portable parameter-based licensing techniques are described. These techniques allow licenses to be decoupled from any particular host device and utilized in a portable and flexible fashion. In at least some embodiments, license data that includes a license to use computer-related functionality can be stored in a secure execution environment. The secure execution environment can be provided by a suitable secure execution environment hosting device(s) (SEHD), such as a portable flash memory device for instance. The license data in the secure execution environment can then be utilized to authorize use of the computer-related functionality, according to the license, on any number of host devices not responsible for providing the secure execution environment. As a result, the owner of the license can use the computer-related functionality without being restricted to any particular host device.

### BACKGROUND

Traditional licensing techniques associated with software and/or hardware functionality are relatively rigid in that they offer little in terms of portability. This is at least partly because licenses for this type of functionality are typically tied to a particular computing device. For example, when a user purchases a software product, they often receive a product key or other similar indication of ownership. The user must then activate the product key, and thus the license, for their computing device within a certain period of time in order to continue using the product. The user, however, may want to use the software on another computing device, such as on a relative's computer for instance. However, if the user attempts to install the software on the other computing device and activate the product key, the activation will likely fail. As such, due to this lack of portability, the user is limited with respect to utilizing their license.

In addition, these types of licenses are also relatively rigid because they typically lack flexibility with respect to their terms of usage. For example, the user may have purchased a non-perpetual 120-day license to use the software product. In this regard, the user may wish to use the product incrementally such that the 120 days are spread over multiple separate usage sessions, with the usage time of the license only being decreased during those sessions. Unfortunately however, non-perpetual licenses of this type typically either expire on a pre-determined date/time or permit a certain pre-determined amount of usage time (e.g., a certain number of days) that decreases serially during a single consecutive usage session once the product's key is activated.

### SUMMARY

Portable parameter-based licensing techniques are described herein. These techniques allow licenses to be decoupled from any particular host device and utilized in a portable and flexible fashion. For example, a license may include a number of fractional licenses each of which can be associated with and permit a particular available scope of usage (ASU) for computer-related functionality. Each individual fractional license may be used or consumed (i.e., utilized to authorize use of the computer-related functionality) consecutively in a session, or intermittently over multiple sessions.

In at least some embodiments, license data that includes a license to use computer-related functionality can be stored in a secure execution environment. The secure execution environment can be provided by a suitable secure environment hosting device(s) (SEHD), such as a portable flash memory device or computing device(s) for instance. The license data in the secure environment can then be utilized to authorize consecutive or intermittent use of the computer-related functionality, according to the license, on any number of host devices not responsible for providing the secure execution environment. As a result, the owner of the license can use the computer-related functionality without being restricted to any particular host device.

For example, the SEHD can be communicatively linked with a first host device. The license data in the secure execution environment can then be utilized to authorize use of the computer-related functionality on the first host device. Put another way, the license can then be consumed on the first host device. In at least some embodiments, a portion of the license can be exported to the first host device as a new license. This new license may be used or consumed on the first host device even after the SEHD is no longer communicatively linked with the first host device. The SEHD can then be communicatively linked with a second different host device. The license data in the secure execution environment can then be utilized to authorize use of the computer-related functionality on the second host device. Put another way, the license can then be consumed on the second device.

### BRIEF DESCRIPTION OF THE DRAWINGS

FIG. 1 illustrates an example license in accordance with one or more embodiments

FIG. 2 illustrates an example of an operating environment in accordance with one or more embodiments.

FIG. 3 illustrates an example of a system in accordance with one or more embodiments.

FIG. 4 illustrates an example of a secure execution environment in accordance with one or more embodiments.

FIG. 5 illustrates an example of a portable licensing module in accordance with one or more embodiments.

FIG. 6 illustrates an example of a system in accordance with one or more embodiments.

FIG. 7 illustrates a flow diagram that describes steps in a method in accordance with one or more embodiments.

FIG. 8 illustrates a flow diagram that describes steps in a method in accordance with one or more embodiments.

### DETAILED DESCRIPTION

### Overview

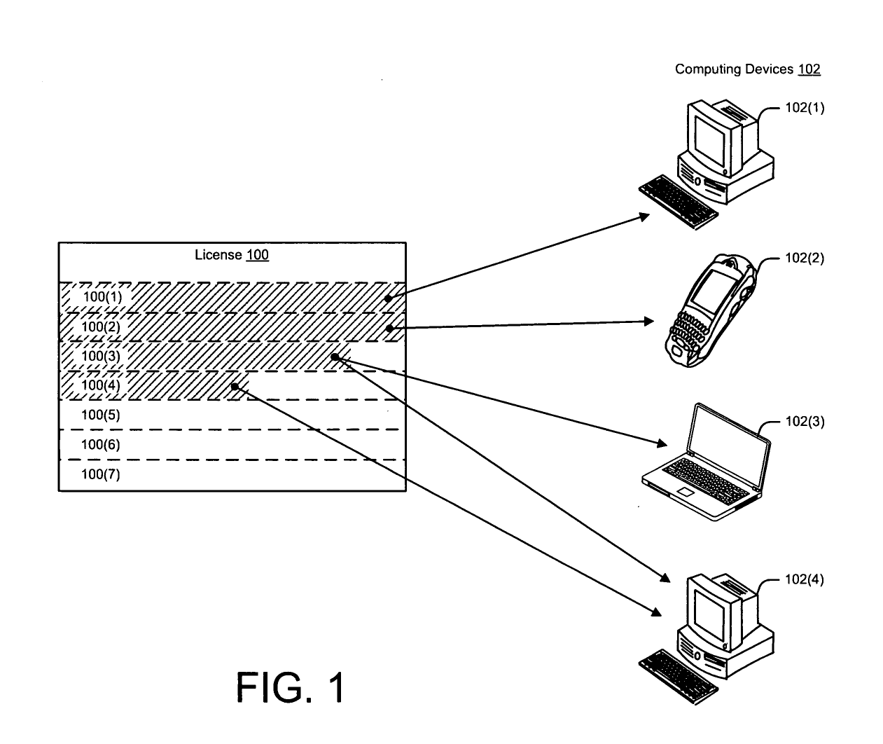

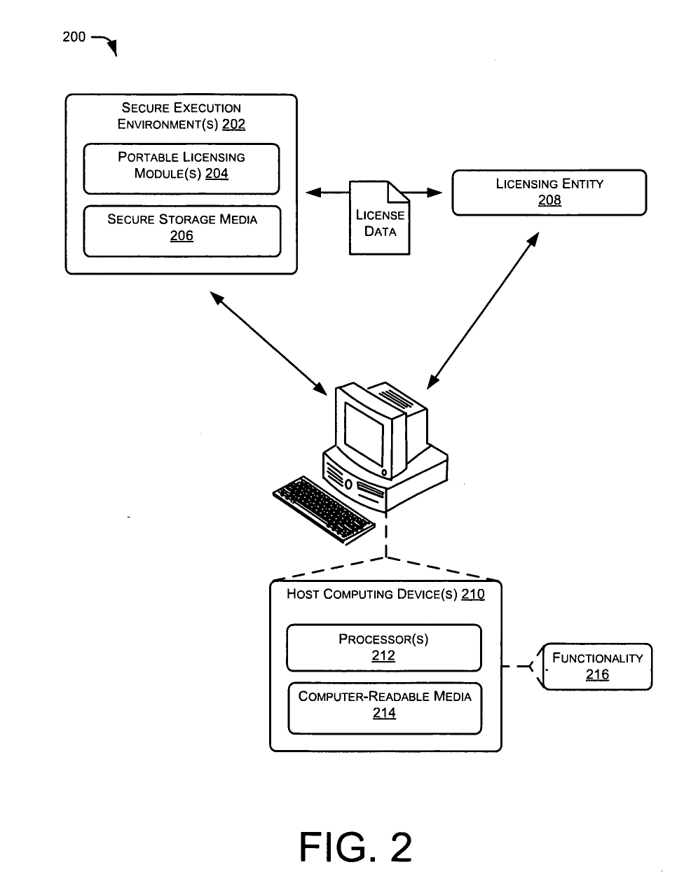

Portable parameter-based licensing techniques are described. These techniques allow licenses to be decoupled from any particular host device and utilized in a portable and flexible fashion. To assist the reader in appreciating this, consider FIG. 1 which illustrates an example license 100. In this example, license 100 includes a number of fractional licenses 100(1)-100(7), each of which can be associated with and permit a particular available scope of usage (ASU) for computer-related functionality (hereinafter “functionality”). Briefly, ASU can be thought of as the extent of usage of functionality permitted or authorized under the terms of a particular license. ASU can be defined and measured according to one or more metrics such as time and/or available functionality levels for instance. Further detailed examples of functionality and ASU are illustrated and described below, such as with respect to FIGS. 2, 3 and 6 for instance.

While license 100 is shown as including seven fractional licenses, it is to be appreciated and understood that license 100 can include any number of fractional licenses. Furthermore, it is to be appreciated and understood that fractional licenses 100(1)-100(7), and/or any number of additional fractional licenses, may be acquired (e.g., on-line from a licensing entity) at any time. Examples of acquiring license data from a licensing entity are illustrated and described in more detail below, such as with respect to FIGS. 2, 3, and 6 for instance. In this regard, individual fractional licenses 100(1)-100(7) may each have differing levels of granularity with respect to their ASU. For instance, in this example assume that license 100 is a license for six months of consecutive or intermittent usage of the functionality. Furthermore, assume that license 100 is subdivided into six discrete one-month fractional licenses: 100(1)-100(6). In addition, also assume that fractional license 100(7) is an additional fractional license for an additional month of usage of the functionality that was acquired after fractional licenses 100(1)-100(6) were acquired.

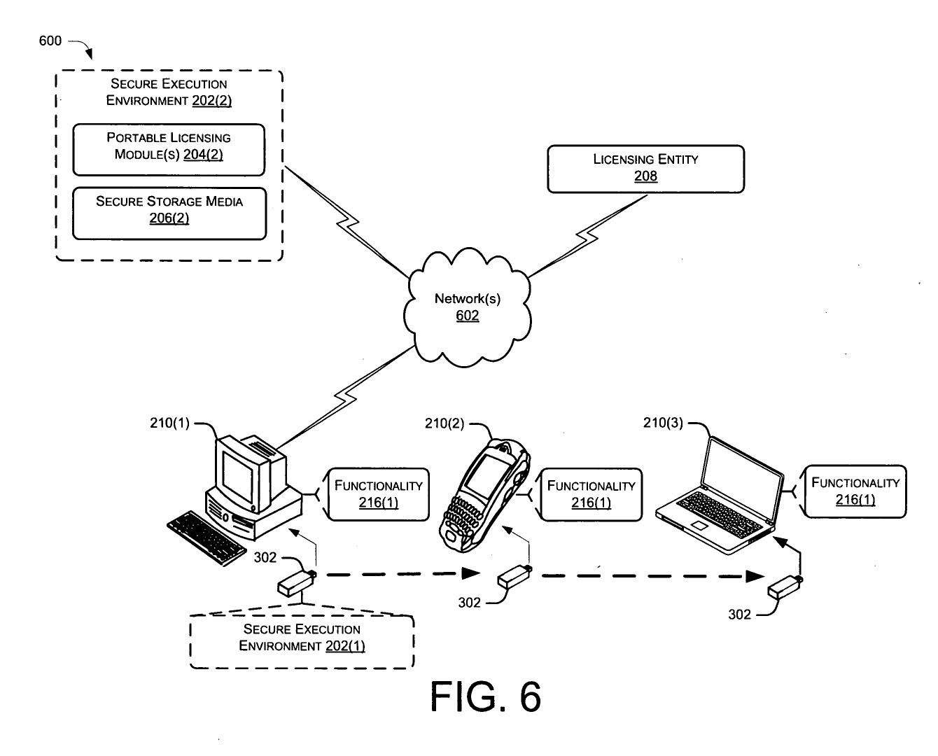

As discussed in detail below, in at least embodiments, license 100 can be stored on one or more secure storage media in the secure execution environment. A portable licensing module in the secure execution environment can be configured to split license 100 into one or more portions (e.g. fractional licenses 100(1)-100(7)) that can be exported to any number of host devices, meter the use of license 100 and/or any of the portions, and or modify (e.g., decrement) the ASU of 100 and/or any of the portions. Stated another way, in some implementations, the secure execution environment can actually split license 100 and/or any of fractional licenses 100(1)-100(7) into smaller pieces based upon time, usage, and/or some other parameter. For instance, the secure execution environment can divide a one-day license into twenty four one-hour sub-licenses that can be used serially or concurrently. A more detailed example is described below relative to FIG. 6.

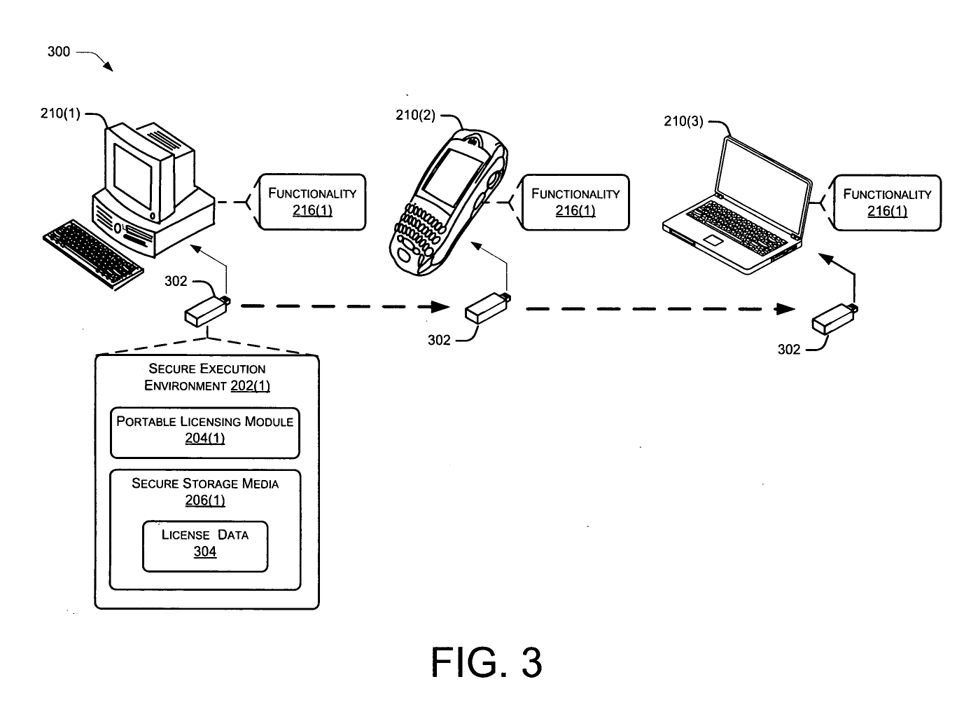

Each of individual fractional licenses 100(1)-100(7) can be used or consumed (i.e., utilized to authorize or permit usage of the functionality) consecutively in a session, or intermittently over multiple sessions, by one or more authorized users. Furthermore, all or part of each of the fractional licenses may be used or consumed on any number of computing devices by an authorized user(s) in a highly portable and flexible fashion. For instance, in this example, fractional licenses 100(1)-100(4) may be used on various computing devices 102. More particularly, assume here that all of fractional license 100(1) has been consumed on computing device 102(1) and that all of fractional license 100(2) has been consumed on computing device 102(2). Furthermore, assume that part of fractional license 100(3) has been consumed on computing device 102(3) and that another part of license 100(3) has been consumed on computing device 102(4). Further still, assume that part of fractional license 100(4) has also been consumed on computing device 102(4). Finally, assume that fractional licenses 100(5)-100(7) have not been consumed and are thus available for subsequent use. Further detailed examples of utilizing a license in such a portable and flexible fashion are illustrated and described below, such as with respect to FIGS. 3 and 6 for instance.

As noted above, in at least some embodiments, license data that includes a license to use functionality, such as license 100 described above for example, can be stored in a secure execution environment. The secure execution environment can be provided by any suitable secure environment hosting device(s) (SEHD), such as a portable flash memory device or computing device for instance. Further detailed examples of various suitable SEHDs are described below with respect to FIG. 2. The license data in the secure execution environment can then be utilized to authorize use of the functionality, according to the license, on any number of host devices not responsible for providing the secure execution environment, such as computing devices 102(1)-102(4) for example. As a result, the owner of the license can use the functionality without being restricted to any particular host device.

For example, the SEHD can be communicatively linked with a first host device. The license data in the secure execution environment can then be utilized to authorize use of the computer-related functionality on the first host device. Put another way, the license can then be consumed on the first host device. In at least some embodiments, a portion of the license can be exported to the first host device as a new license. This new license may be used or consumed on the first host device even after the SEHD is no longer communicatively linked with the first host device. The SEHD can then be communicatively linked with a second different host device. The license data in the secure execution environment can then be utilized to authorize use of the computer-related functionality on the second host device. Put another way, the license can then be consumed on the second device.

In one or more embodiments, the license data can be stored on one or more secure storage media in the secure execution environment. As noted above, a portable licensing module in the secure execution environment can utilize the license data to authorize usage of the functionality on a host device. The portable licensing module can authorize the usage in a variety of ways, such as noted briefly above. Without limitation, this can include validating to the host device that the license permits the usage, exporting a new license to the host device, allowing the host device to read all or part of the license data, and/or metering the usage on the host device. For example, with respect to metering, the portable licensing module can be configured to periodically receive a confirmation signal of usage of the functionality from the host device (e.g., from a software application) and in response, periodically provide an authorization signal to the host device permitting continued usage.

Multiple and varied implementations and embodiments are described below. Generally, any of the features/functions described with reference to the figures can be implemented using software, hardware, manual processing, or any combination thereof. The term license (or licenses) as used herein generally represents a license(s) for software and/or hardware functionality which may, in at least some embodiments, include one or more discrete fractional licenses such as fractional licenses 100(1)-100(7) for example. The terms “software” as used herein generally represent any computer-readable code or other instructions and can include, without limitation, software applications (including web or Internet-based applications executable on a server and displayable locally on a host device), firmware (e.g., fixed logic circuitry), middleware, system software (e.g., an operating system), services, and/or other instructions that can be stored on computer-readable media, and that when executed or otherwise implemented, provide functionality.

Furthermore, the computer-readable media can include, without limitation, all forms of volatile and non-volatile memory and/or storage media. Such media can include read only memory (ROM), random access memory (RAM), flash memory, hard disk, removable media, and the like. The terms “module” or “component” as used herein generally represent software, hardware, or any combination thereof. For instance, the terms “module” or “component” can represent program code (or declarative content) and/or other types of instructions that perform specified tasks when executed on a processing/computing device or devices. The program code can be stored in one or more computer-readable media.

More generally, the illustrated separation of modules, components and functionality into distinct units may reflect an actual physical grouping and allocation of such software and/or hardware. Alternatively or additionally, the separation can correspond to a conceptual allocation of different tasks to one or more software program(s) and/or hardware unit(s), or any combination thereof. The illustrated modules, components, and functionality can be located at a single site (e.g., as implemented by a computing device), or can be distributed over multiple locations (e.g., as implemented by multiple computing devices).

### Operating Environment Example

FIG. 2 illustrates an example operating environment, generally at 200, in accordance with one or more embodiments. Example environment 200 can include one or more secure execution environment(s) 202 in which the portable time based licensing techniques described herein can be implemented.

In this regard, secure execution environment(s) 202 can include one or more portable licensing module(s) 204 which can be configured to provide various licensing-related operations via one or more corresponding functional interfaces. As such, portable license module(s) 204 can be implemented in secure execution environment(s) 202. Secure execution environment(s) 202 can also include, among other things, one or more secure storage media 206. License data can be safely stored on secure storage media 206 and securely accessed by other modules or components of the secure execution environment(s), such as portable licensing module(s) 204 for instance. In at least some embodiments, access to secure storage media 206 can be controlled to prevent unauthorized access of the license data.

Secure execution environment(s) 202 can be implemented on, or otherwise provided by, any suitably configured SEHD (not shown). For example, in at least some embodiments a portable memory device, such as a Universal Serial Bus (USB) flash drive, Secure Digital (SD) card, or the like can be utilized as a SEHD. Alternatively or additionally, in at least some embodiments, one or more computing devices such as, without limitation, a server computing device, desktop computing device, hand-held computing device, laptop computing device, personal digital assistant (PDA), smart phone, or the like can be utilized as a SEHD(s).

Portable licensing module(s) 204 can be configured to communicate with entities that are not associated with providing secure execution environment(s) 202. Here, these entities can include a licensing entity 208 and host computing device(s) 210. That is to say, entities other than the device(s) responsible for implementing or otherwise providing secure execution environment(s) 202 may be communicatively linked with the secure execution environment(s). In this regard, the SEHD(s) of secure execution environment(s) 202 can be configured with one or more suitable input/output modules (not shown) to enable the secure execution environment(s) to be communicatively linked. Without limitation, the suitable input/output module(s) can be associated with any suitable method/protocol, including USB, BLUETOOTH, RS232, PS2, CAN, TCPIP, Serial ATA, Parallel ATA, Institute of Electrical and Electronics Engineers (IEEE) 1394 standard, and the like.

Licensing entity 208 can be a provider of licenses to use the functionality. As noted above, these licenses can be for functionality associated with software and/or hardware. Licensing entity 208 can include a manufacturer, vendor, and/or other type of entity capable of providing a license to secure execution environment(s) 202. For example, in the context of functionality associated with software, licensing entity 208 might be a software manufacturer from which individual licenses for various software applications, operating systems, and/or upgrades for such can be purchased and stored in secure storage media 206.

In this example, portable licensing module(s) 204 can be configured to obtain one or more licenses and/or portions of licenses (e.g., fractional license(s)) from licensing entity 208. This might include obtaining a license that includes one or more fractional licenses from licensing entity 208 and then, in some circumstances, subsequently obtaining additional fractional licenses from licensing entity 208. In at least some embodiments, this can be accomplished by portable licensing module(s) 204 utilizing functionality of the SEHD (e.g., one or more processors and/or software on the SEHD) to authenticate secure execution environment(s) 202 with the licensing entity, provide payment information to the licensing entity if necessary, and receive license data that includes the license(s). In addition, in at least some embodiments, the license data can also include metadata describing the license(s). For example, the metadata can be used to describe an ASU associated with and permitted by the license(s).

In at least some embodiments, individual licenses for the functionality can be obtained from licensing entity 208 which vary in their ASU. For example, in the context of software functionality, a particular license may be associated with, and thus permit, perpetual use of an upgraded version of a software product. Another license, however, may permit a limited amount of usage time of a basic version of the software product having fewer software features.

As noted above, the ASU of a particular license can be defined by, and thus adjusted (e.g., decremented or incremented) and/or indexed according any number of suitable parameters such as, without limitation, time increments of available functionality usage (e.g., months, days, hours, minutes, etc.), available functionality feature levels (e.g., software versions, tiers, etc.), and/or pre-defined usage tracking units (e.g., dollars, points, etc.).

For example, the ASU of an example license might be defined by a number of minutes such that a discrete portion or portions of minutes can be used concurrently or intermittently. The ASU can be decremented accordingly for each individual usage. As such, the example license might be considered to be a pre-paid license that permits a certain number of minutes of usage before it expires. While described here in the context of host computing device(s) 210, these minutes would not necessarily be tied to any particular host device or devices unless/until they are transferred from the SEHD to the host device(s) (e.g., via a fractional license).

In this example, host computing device(s) 210 can include one or more processors 212 and one or more computer-readable media 214. Computer-readable media 214 can include, without limitation, all forms of volatile and non-volatile memory and/or storage media that are typically (or can be) associated with a computing device. Such media can include ROM, RAM, flash memory, hard disk, removable media, and the like.

Host computing device(s) 210 can be configured to implement or otherwise provide functionality 216 which is subject to a license included in the license data obtained from licensing entity 208 and securely stored in secure storage media 206. As noted above, functionality 216 can be associated with software and/or hardware. By way of example and not limitation, this can include a software application, operating system, a software application upgrade to a higher feature level, an operating system upgrade to a higher feature level, a hardware (e.g., network interface card or processor) functionality upgrade, or the like. As such, portable licensing module(s) 204 can be utilized to authorize the usage of functionality 216 on host computing device(s) 210 based on the obtained license data. Host computing device(s) 210 can include any suitable type of computing device such as, without limitation, a desktop computing device, hand-held computing device, laptop computing device, personal digital assistant (PDA), smart phone, or the like.

By virtue of being stored separately from host computing device(s) 210, the license for functionality 216 can be decoupled from host computing device(s) 210 and can thus be utilized in a portable and granular fashion by the license's owner. One such example of this is illustrated and described with respect to the example system in FIG. 3.

### First System Example

FIG. 3 illustrates an example system, generally at 300, in which various embodiments of the portable parameter-based licensing techniques described herein can be implemented. For discussion purposes, system 300 is illustrated and described in the context of example operating environment 200 of FIG. 2. However, it is to be appreciated and understood that system 300 can be implemented independently of any particular operating environment.

In this example, system 300 can include three host computing devices: 210(1), 210(2) and 210(3). For purposes of illustration, these devices are represented here as a desktop computer, PDA, and laptop computer respectively. However, it is to be appreciated and understood that each of these computing devices can be any suitable type of computing device. For purposes of discussion, assume that each of these host computing devices is configured to implement or otherwise provide functionality 216(1).

System 300 can also include a portable device 302 configured to implement or otherwise provide a secure execution environment 202(1). As such, portable device 302 can be a SEHD for secure execution environment 202(1). In this example, portable device 302 is represented as a portable memory device in the form of a USB flash memory device. However, it is to be appreciated and understood that any suitable portable device can be used without deviating from the spirit and scope of the claim subject matter. For example, as noted above, in at least some embodiments, portable device 302 can be a portable memory device in the form of an SD card, or the like. Alternatively or additionally, in at least some embodiments, the portable device can be a computing device that can be placed proximate to the host computing device(s) to wirelessly communicate with them—such as a Bluetooth enabled device for example.

Secure execution environment 202(1) can include a portable licensing module 204(1) which, as noted above, can be configured to provide various licensing related operations via one or more corresponding functional interfaces. Secure execution environment 202(1) can also include one or more secure storage media 206(1) on which license data 304 can be securely stored and accessible to modules and/or components of secure execution environment 202(1), including portable licensing module 204(1). For purposes of discussion, assume that license data 304 has been obtained from a licensing entity (e.g., licensing entity 208) and securely stored on secure storage media 206(1). In addition, assume that license data 304 includes a license to use functionality 216(1) and/or metadata describing an ASU for functionality 216(1). For example, the metadata may describe one or more ASU parameters, such as those described above.

In this example, portable device 302 is first shown as being removeably attached to host computing device 210(1) in order to establish a communicative link with it. Recall that host computing device 210(1) is configured such that it is capable of providing functionality 216(1). As such, portable licensing module 204(1) can utilize license data 304 to authorize the usage of functionality 216(1) on host computing device 210(1).

Portable licensing module 204(1) can authorize the usage of functionality 216(1) on host computing device 210(1) in a variety of ways. Without limitation, this can include validating to host computing device 210(1) that the license permits the usage, metering the usage on host computing device 210(1), exporting a new license to use the functionality to host computing device 210(1), and/or allowing host computing device 210(1) to read all or part of the license data.

Additionally or alternatively, in at least some embodiments, portable licensing module 204(1) can allow host computing device 210(1) to read all or part of the license data. This may facilitate the host computing device regulating the usage of the functionality and/or providing information to a user, such as the license's owner for instance.

By virtue of license data 304 being securely stored on secure storage media 206(1)—rather than on host computing device 210(1) or another host device—usage of functionality 216(1) according to the license is not tied to a particular host device. For example, here portable device 302 can simply be detached from host computing device 210(1) to terminate the communication link between these devices. In at least some embodiments, detaching portable device 302 from host computing device 210(1) can be sufficient to terminate the authorization of the usage of functionality 216(1). Alternatively or additionally, the owner might choose to instruct, via a user interface or other means, portable licensing module 204(1) to terminate the authorization. In at least some other embodiments, the owner might choose to export all or part of the license (e.g., a fractional license) as a new license to host computing device 210(1) such that usage of the functionality can be authorized after portable device 302 is detached.

Once portable device 302 is detached from host computing device 210(1), it can be moved to another different host computing device and removeably attached to it. Accordingly, portable device 302 is shown here as being moved to computing device 210(2). This movement is represented by the dotted line pointing to portable device 302 being removeably attached to, and thus communicatively linked with, host computing device 210(2). Recall that host computing device 210(2) is also configured such that it is capable of implementing or otherwise providing functionality 216(1). Accordingly, once host computing device 210(2) is communicatively linked with portable device 302, portable licensing module 204(1) can utilize license data 304 to authorize the usage of functionality 216(1) on host computing device 210(2) in a manner similar to that described with respect to host computing device 210(1).

To further illustrate the portability available by securely storing license data 304 in secure execution environment 202(1), portable device 302 is further shown as being detached from host computing device 210(2) and moved to host computing device 210(3). This movement is represented here by the dotted line pointing to portable device 302 being removeably attached to, and thus communicatively linked with, host computing device 210(3). Once host computing device 210(3) is communicatively linked with portable device 302, portable licensing module 204(1) can utilize license data 304 to authorize the usage of functionality 216(1) on host computing device 210(3).

To assist the reader in appreciating the above discussion, consider an example scenario where functionality 216(1) is a software application and license data 304 includes a license to use a premium version of the software application (a premium version license). Furthermore, assume that each of host computing devices 210(1), 210(2), and 210(3) are capable of implementing the software application. As such, these host computing devices are capable of providing functionality of the software application to the owner of the premium version license (the user). In this regard, also assume that host computing device 210(1) is the user's primary desktop computing device, host computing device 210(2) is the user's PDA device, and host computing device 210(3) is a laptop computing device belonging to the user's relative who lives in a different city than the user.

By virtue of the premium version license being securely stored separately from any of the host computing devices, the user can use the software application under the premium version license on any suitable host computing device simply by receiving authorization from portable licensing module 204(1). For example, the user may first receive authorization, based on the premium version license, to use the premium version on his/her desktop (host computing device 210(1)) when at home. The user may then receive authorization, based on the same premium version license, to use the premium version on his/her PDA (host computing device 210(2)) while traveling to their relative's home.

Once the user arrives at his/her relative's home, he/she may choose to use their relative's laptop (host computing device 210(3)). Their relative, however, may only have a license to use the basic version of the software application. Nevertheless, the owner may receive authorization based on the premium version license to use the premium version of the software application on the laptop. Furthermore, in at least some embodiments, by virtue of the described portable parameter-based licensing techniques, the user may even choose to export all or part of the premium version license as a new license to their relative's laptop for use on the laptop after they leave.

### Secure Execution Environment Example

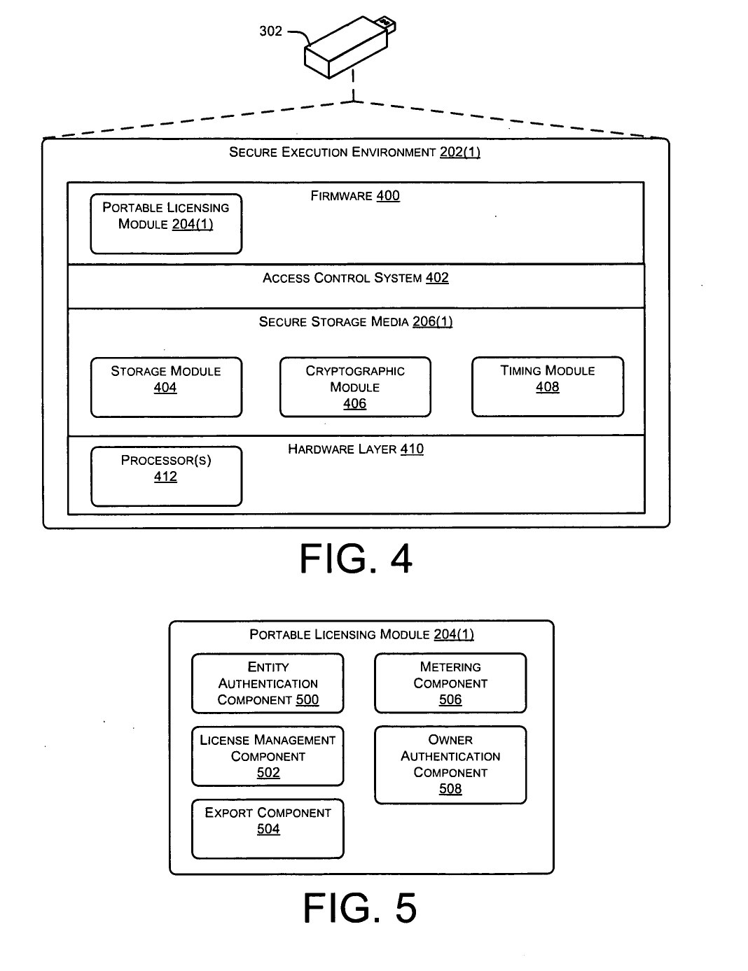

For discussion purposes, and to provide the reader with an example of a secure execution environment, FIG. 4 illustrates a detailed view of secure execution environment 202(1) provided by portable device 302. Like numerals from FIG. 3 have been utilized to depict like components. However, it is to be appreciated and understood that FIG. 4 illustrates but one example of a secure execution environment, and is thus not to be interpreted as limiting the scope of the claimed subject matter.

As noted above and shown in FIG. 4, portable device 302 is represented as a USB flash memory device. As such, secure execution environment 202(1) is illustrated and described in the context of being implemented on such a device. More particularly, secure execution environment 202(1) includes firmware 400 which can provide a communication channel between the secure execution environment and a host computing device, licensing entity, or other entity external to secure execution environment 202(1). Firmware 400, in turn, includes portable licensing module 204(1) which is described in more detail below.

Secure execution environment 202(1) also includes an access control system 402 that can be configured to control access to secure storage media 206(1) of secure execution environment 202(1) by regulating communications to and/or from the secure storage media. By way of example and not limitation, access control system 402 may ensure that a licensing entity and/or host device is properly authenticated with secure execution environment 202(1) before allowing access. As such, unauthorized tampering can be prevented.

As noted above, portable licensing module 204(1) can be configured to provide various licensing related functions via various components and corresponding functional interfaces. More particularly, in at least some embodiments, portable licensing module 204(1) can include or otherwise be associated with computer-readable code or other types of instructions. For example, portable license module 204(1) can be computer-readable instructions of firmware 400 which, when executed in the secure execution environment of secure execution environment 202(1), perform the licensing related operations described herein.

Portable licensing module 204(1) can include any number of suitable interfaces for communicating with internal modules and components within secure execution environment 202(1), and/or with entities external to secure execution environment 202(1). Without limitation, example suitable interfaces can include one or more USB Mass Storage Class (MSC) interfaces, USB Human Interface Device (HID) interfaces, or the like. In at least some embodiments, portable licensing module 204(1) can be configured such that communications between secure execution environment 202(1) and external entities conforms to the IEEE 1667 Standard Protocol for Authentication in Host Attachments of Transient Storage Devices. Alternatively or additionally, portable licensing module 204(1) can be configured such that these communications conform to one or more other suitable protocols.

In this example, secure storage media 206(1) includes a storage module 404, a cryptographic module 406, and a timing module 408. Storage module 404 can be configured to safely store license data, such as license data 304 for example, cryptographic keys, and/or any other sensitive information in secure storage media 206(1). Cryptographic module 406, in turn, can include cryptographic hardware and/or other components configured to perform cryptographic functions (usable by access control system 402 for instance). Without limitation, these cryptographic functions can include generating cryptographic (e.g., public and/or private) keys, verifying cryptographic keys, decrypting data, encrypting data, or the like. Timing module 408 can include a timing mechanism such as an oscillator and/or internal powered clock usable by any module and/or component in secure execution environment 202(1). For instance, portable licensing module 204(1) can utilize timing module 408 to track increments of time or perform any other time-related operations (e.g., expiring licenses, metering, exporting new licenses, modifying ASUs, etc.).

In at least some embodiments, secure execution environment 202(1) can also include a hardware layer 410. Hardware layer 410 may include one or more processors 412 for executing computer-readable instructions. The hardware layer and processor are presented to orient the reader and are not described further herein.

### Portable Licensing Module Example

To assist the reader in appreciating the features provided by the described portable licensing module(s), FIG. 5 illustrates a detailed view of portable licensing module 204(1) provided by portable device 302. Accordingly, FIG. 5 is described collectively with reference back to components of FIG. 4. Like numerals from FIG. 4 have been utilized to depict like components. However, it is to be appreciated and understood that FIG. 5 illustrates but one example of a secure execution environment, and is thus not to be interpreted as limiting the scope of the claimed subject matter.

In this example, portable licensing module 204(1) can include various components configured to provide operations associated with the described licensing techniques. More particularly, portable licensing module 204(1) can include an entity authentication component 500 that can be utilized to authenticate a licensing entity (e.g., licensing entity 208) and then obtain license data.

More particularly, in at least some embodiments, entity authentication component 500 can utilize a key pair generated by cryptographic module 406 (FIG. 4). This key pair can include a public key and a private key. In this regard, entity authentication component 500 can initiate communication with the licensing entity by, for example, requesting a license from the entity and providing the entity with the public key (which identifies portable device 302). Furthermore, if necessary, suitable payment information, e.g., credit card information, may also be provided in an encrypted form to the licensing entity. In response, the licensing entity may then encrypt license data (that includes the requested license) using the public key and send the encrypted license data to portable licensing module 204(1).

Once the encrypted license data is received by portable licensing module 204(1), entity authentication component 500 can utilize cryptographic module 406 to decrypt the encrypted license data using the private key to obtain the license data. In this regard, storage module 404 can be utilized to securely store the encrypted and/or the decrypted license data (i.e., the license data) in secure storage media 206(1). Furthermore, in at least some embodiments, the licensing entity may include a public key identifying the licensing entity in its response to portable licensing module 204(1). Entity authentication component 500 can then utilize the entity public key to authenticate the licensing entity thereafter.

Portable licensing module 204(1) can also include a license management component 502 that can be utilized to modify license data and/or allow access to license data. More particularly, in at least some embodiments, license management component 502 can permit a licensing entity to modify the license data by adding, removing, editing or otherwise changing it. This can be accomplished in any suitable way, such as by receiving instructions from the licensing entity and then carrying out the instructions. For example, the owner of the license stored in secure execution environment 202(1) may contact the licensing entity after they lose portable device 302 or have it stolen. The licensing entity may then attempt to communicatively link with portable device 302. If the licensing entity is able to communicatively link with the portable device, entity authentication component 500 can authenticate the licensing entity utilizing, for instance, the public key provided by the licensing entity. Once authenticated, the licensing entity can then communicate instructions to license management component 502 to remove, delete, or otherwise inactivate the license.

As another example, the license owner may wish to supplement the ASU of the license (e.g., add additional units of usage time, add available functionality, etc.) and thus may contact the licensing entity to obtain/purchase the additional ASU. The licensing entity can then communicatively link with portable device 302. Once linked, entity authentication component 500 can authenticate the licensing entity and license management component 502 can then allow the licensing entity to edit the license to supplement the ASU and/or make other appropriate changes.

Furthermore, in at least some embodiments, license management component 502 can allow a host computing device access to read a public portion of the license data. This access may, for example, facilitate the host computing device (e.g., via a software application implemented on the host computing device) to regulate use of the particular license (e.g., based on the ASU of the license). Alternatively or additionally, this access may facilitate the host computing device to provide a user (e.g., the license owner) with information about the license (e.g., its ASU) and/or with access to the public license data.

License management component 502 can, in at least some embodiments, authorize usage of functionality by validating to the host device that the license is stored in secure storage media (i.e., that the license is present) and/or by validating to the host computing device that a particular usage of the functionality is permitted by the license under its ASU. This can be accomplished in any suitable way. For example, in at least some embodiments, licensing management component 502 may securely communicate a message to the host computing device sufficient to indicate to the host device that the usage of the functionality is permitted. Alternatively or additionally, licensing management component 502 may provide the host computing device with read access to the public portion of the license data sufficient to allow the host device to validate that the ASU of the license permits the usage. For example, consider a scenario where the functionality is provided by a software application implemented on the host computing device. The software application and/or other software (e.g., an operating system implemented on the host computing device) might be configured to seek confirmation from license management component 502 before allowing the user to access the functionality.

Portable licensing module 204(1) can also include an export component 504. Export component 504 can be utilized to authorize, based on the license data, the usage of the functionality on the host device by exporting a new license for the functionality to the host device. More particularly, in at least some embodiments, export component 504 can generate the new license such that it has a new ASU that is equal to or less than the ASU of the original license. Put another way, export component 504 can effectively subdivide the original license by creating a new license with all or part of the ASU of the original license. Export component 504 can then modify (e.g., decrement) the ASU of the original license accordingly such that the new ASU of the new license and the new ASU of the original license do not exceed the original ASU. In this regard, export component 504 can utilize timing module 408 with respect to accounting for and/or modifying any time parameters associated with the original and/or new ASU. Once the new license has been generated, export component 504 can then supply the host device with the new license and, in at least some embodiments, metadata for the new license.

Portable licensing module 204(1) can further include a metering component 506. Metering component 506 can be utilized to authorize, based on the license data, the usage of the functionality by periodically metering the usage on the host device. More particularly, metering component 506 can provide, for each of one or more time periods, permission to the host device to use the functionality. These one or more time periods can be represented by any time duration unit, whether it be months, days, hours, minutes, seconds, or any other time duration unit. In at least some embodiments, the appropriate time duration units to be used can be designated by the host device (e.g., via a software application implemented on the host computing device). For example, again consider the scenario where the functionality is provided by a software application implemented on the host computing device. The software application and/or other software (e.g., an operating system implemented on the host computing device) might be configured to provide portable licensing module 204(1) with information designating the time duration unit to be used.

Metering component 506 can then decrement, if appropriate, the ASU of the license for each of the time periods—thus accounting for the duration or amount of time the functionality was used.

In at least some embodiments, metering component 506 can use a “heartbeat” monitoring technique to meter the usage of the functionality. For example, metering component 506 may periodically receive (at any time interval) confirmation signals from the host device while portable device 302 remains communicatively linked with the host device. In response to receiving each confirmation signal, metering component 506 can provide (i.e., send) an authorization signal back to the host device. The authorization signal, by virtue of being received by the host device, may itself be sufficient for the host device to determine that the usage is authorized. Alternatively or additionally, the authorization signal may include data that expressly indicates to the host device that the usage is authorized.

Furthermore, in the event the license is not associated with an unlimited ASU or is otherwise not subject to being decreased by the usage, metering component 506 can incrementally decrement the ASU based at least in part on the amount of time that that the functionality was used. For example, in the context of the “heartbeat” monitoring technique, metering component 506 can utilize license management component 502 to decrement the ASU of the license. In this regard, the ASU can be decremented for each time period associated with receiving the confirmation signals and/or providing the authorization signals. In at least some embodiments, the ASU can be decremented in real-time during the metering (e.g., after each confirmation signal is received and/or authorization signal provided). Alternatively or additionally, the ASU can be decremented after a metered usage event has ended (e.g., after the last confirmation signal is received and/or authorization signal provided).

Since any number of confirmation and/or authorization signals may be sent, the duration of time associated with a metered usage event might be of any length. To measure the elapsed time of usage events, metering component 506 can utilize timing module 408.

With respect to determining the extent to decrement the ASU, any suitable parameters can be taken into account. For example, recall that the ASU of a particular license can be defined by, and thus adjusted and/or indexed according to, various types of parameters (e.g., time periods, available functionality feature levels and/or pre-defined usage tracking units). As such, in at least some embodiments, one or more of the parameters (e.g., the feature level of the functionality) may be used to influence the extent by which the ASU is decremented.

In one or more embodiments, all or part of the metering functionality described above with respect to metering component 506 can be performed on a device other than the SEHD(s) providing secure execution environment 202(1) (i.e., portable device 302 in this example). For example, in the context of the scenario where the functionality is provided by a software application implemented on the host computing device, the software application and/or other software (e.g., an operating system implemented on the host computing device) might be configured to provide all or part of the metering functionality described above with respect to metering component 506. Such embodiments can allow metering to continue and eventually time-out even if the SEHD(s) is communicatively unavailable to the host device.

In addition to the above described components, portable licensing module 204(1) can also include an owner authentication component 508 which can be utilized to authenticate secure execution environment 202(1) with the host computing device. In at least some embodiments, this can include verifying to the host computing device that the user is the owner of the license (stored in secure storage media 206(1)). Alternatively or additionally, this can include verifying the ownership of portable device 302 to the host computing device.

In at least some embodiments, owner authentication component 508 can also be utilized to authenticate the user when they interact with portable device 302 via an interface of portable licensing module 204(1) (e.g., via an HID driver an MSC driver, etc.). Furthermore, in at least some embodiments, multiple distinct users may each be able to be authenticated by owner authentication component 508 and may each be associated with one or more distinct licenses stored in secure storage media 206(1). In this regard, license management component 502 may be utilized to ensure that each distinct license is properly associated with its appropriate owner and/or the appropriate licensing entity from which it was obtained.

### Second System Example

Recall that secure execution environment(s) 202 can be implemented on, or otherwise provided by, any suitably configured SEHD(s). For example, FIGS. 3-5 above are described in the context of portable device 302 that is a SEHD capable of being positioned proximate to host computing devices 210(1), 210(2), and 210(3) to become communicatively linked with them. However, also recall that in at least some embodiments, one or more computing devices such as a server computing device (herein “the server”) can be utilized as a SEHD. In this regard, the server might be remote from a particular host device or devices (e.g., host computing devices 210(1), 210(2), and 210(3)) such that it is impractical for the server to be placed proximate to these host computing device(s). In such a scenario, the host device(s) and the server can nevertheless still become communicatively linked with one another by communicating remotely via one or more networks.

One example of a system that includes secure execution environments provided by both portable device 302 and the server (not shown) is illustrated in FIG. 6, generally at 600. For discussion purposes, system 600 is illustrated and described in the context of FIGS. 2 and 3, with like numerals from FIGS. 2 and 3 utilized to depict like components. However, it is to be appreciated and understood that system 600 can be implemented independently of any particular environment.

In this example, system 600 can include secure execution environment 202(1) which is implemented on, or otherwise provided by, portable device 302. In addition, system 600 can also include a secure execution environment 202(2) which is implemented on, or otherwise provided by, the server. In this example, secure execution environment 202(2) can be functionally configured in a manner similar to secure execution environment 202(1). More particularly, secure execution environment 202(2) can include a portable licensing module 204(2) and secure storage media 206(2) on which license data can be securely stored.

Here, host computing devices 210(1), 210(2), and/or 210(3) may be communicatively linked with secure execution environment 202(1) by being positioned proximate to it. Alternatively or additionally, one or more of these host computing devices may be communicatively linked with secure execution environment 202(2) by communicating with it via one or more wired and/or wireless networks 602. Without limitation, one or more networks 602 can include one or more local area networks (LANs), wide area networks (WANs), the Internet, or the like.

For discussion purposes, assume that secure execution environment 202(2) is also able to communicatively link with licensing entity 208 via network(s) 602. As such, portable licensing module 204(2) can obtain license data from licensing entity 208 that includes a license for functionality 216(1). Furthermore, this license data can be securely stored on secure storage media 206(2). Alternatively or additionally, portable licensing module 204(2) can obtain the license data from another source, such as from secure execution environment 202(1) for instance. For example, the portable licensing module of portable device 302 might export a new license to secure execution environment 202(2) based on the license stored in secure execution environment 202(1).

Portable licensing module 204(2) can authorize usage of functionality 216(1) on host computing device 210(1) in a manner similar to that described above with respect to the portable device's portable licensing module. As such, by virtue of being securely stored in a location separate from host computing device 210(1), the license for functionality 216(1) stored in secure execution environment 202(2) is decoupled from computing device 210(1). As such, the license can be utilized in a portable and granular fashion in a manner similar to the license for functionality 216(1) stored in secure execution environment 202(1).

For discussion purposes, now assume that a user (the license owner) wishes to use functionality 216(1) on host computing device 210(2) and/or 210(3). If host computing devices 210(2) and 210(3) are able to access network(s) 602 to communicatively link with secure execution environment 202(2), portable licensing module 204(2) can be utilized to authorize the use of functionality 216(1) on these host computing devices. This is because, as noted above, a license for functionality 216(1) is stored in secure execution environment 202(2).

Alternatively or additionally, the portable device's portable licensing module can be utilized to authorize the use of functionality 216(1) on host computing devices 210(2) and 210(3)—without requiring that these host computer devices access network(s) 602. This is because host computing devices 210(2) and 210(3) can be communicatively linked with secure execution environment 202(1) without accessing network(s) 602. To accomplish this, portable device 302 can be removeably attached to, or placed proximate to, host computing devices 210(2) and 210(3).

To provide an example of the advantages of utilizing a portable licensing module provided on a portable SEHD (e.g., portable device 302), consider a scenario where a number of host devices are available to students of a school in a remote rural village without Internet connectivity. An instructor of the school may wish to enable the use of a software application on the host devices. As such, the instructor may travel (with the SEHD) to the nearest Internet cafe or other location where Internet access is available, such as in the nearest city for instance. The instructor may then access the Internet, contact a licensing entity, and obtain a license for the software application on the SEHD. As described above, the license can be associated with, and thus permit, a certain ASU for the software application, such for 120-days of usage for instance. The instructor may then travel back to the village and utilize the portable licensing module to divide the license (and thus its ASU) into a number of fractional licenses with a cumulative ASU less than or equal to the original ASU of the license. For instance, if the license's original ASU was for 120 days, twelve fractional licenses, each permitting a ten-day ASU, might be created. The instructor may then export individual fractional licenses to each of the host devices concurrently and/or intermittently such that the software application can be used on each host device according to the ASU of its fractional license.

### First Method Example

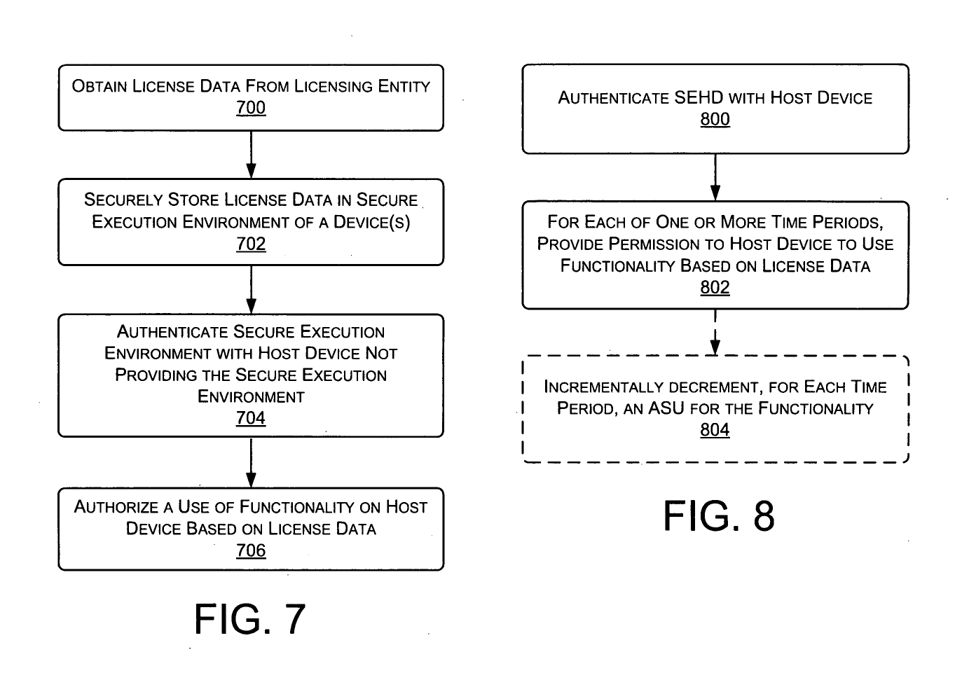

FIG. 7 is a flow diagram that describes steps of a method in accordance with one or more embodiments. The method can be implemented in connection with any suitable software (e.g., including firmware), hardware, or any combination thereof. In one case, the method is stored on a computer-readable storage media as a set of instructions such that execution by a computing device causes the computing device to perform the method. Furthermore, one or more of the steps of the method can be repeated any number of times. In at least some embodiments, the method can be implemented by a system, such as example systems 300 and/or 600 illustrated and described above. However, it is to be appreciated and understood that the described method can be implemented by systems other than systems 300 or 600, without departing from the spirit and scope of the claimed subject matter.

Step 700 obtains license data from a licensing entity. As described above, the license data can include a license for functionality associated with hardware and/or software. The license data can also include metadata describing terms of the license, such as an ASU associated with, and permitted by, the license for example. The ASU can be defined by and/or adjusted according to one or more parameters such as time increments, levels of functionality, dollars, points, etc. In at least some embodiments, this step 700 can include authenticating a secure execution environment with the licensing entity, receiving encrypted license data from the entity, and decrypting the license data in the secure execution environment. In addition, when appropriate, obtaining the license data can also include providing payment information to the licensing entity sufficient to purchase the license.

Responsive to obtaining the license data at step 700, step 702 securely stores the license data in a secure execution environment of one or more devices. By virtue of providing the secure execution environment, this device can be a SEHD. In at least some embodiments, step 702 can include securely storing the decrypted license data in secure storage media of the secure execution environment.

Step 704 authenticates the secure execution environment with a host device (e.g., host computing device(s) 210) not providing the secure execution environment. Put another way, the secure execution environment can be authenticated with a host device that is not the SEHD. As such, the license data—and thus the license for the functionality—can be decoupled from the host device.

In at least some embodiments, such as those described above, step 704 can include verifying to the host computing device that a user of the host device is also the owner of the license. Alternatively or additionally, in at least some embodiments this step can include verifying the ownership of the SEHD to the host device.

Step 706 authorizes a use of the functionality on the host device based on the license data. For example, as noted above, the license data can include the license and metadata describing the ASU of the license, one or both of which may be utilized to authorize the use. In at least some embodiments, such as those described above, step 700 can include: validating that the license permits the use based on the ASU, allowing the host device to read a public portion of the license data, metering the use, and/or exporting a new license for the functionality to the host device.

### Second Method Example

FIG. 8 is a flow diagram that describes steps of a method in accordance with one or more embodiments. The method can be implemented in connection with any suitable hardware, software (e.g., including firmware), or any combination thereof. In one case, the method is stored on a computer-readable storage media as a set of instructions such that execution by a computing device causes the computing device to perform the method. Furthermore, one or more of the steps of the method can be repeated any number of times. In at least some embodiments, the method can be implemented by a system, such as example systems 300 and/or 600 illustrated and described above. However, it is to be appreciated and understood that the described method can be implemented by systems other than systems 300 or 600, without departing from the spirit and scope of the claimed subject matter.

Step 800 authenticates a SEHD, on which license data is stored, with a host device (e.g., host computing device(s) 210). As described above, this step can include verifying to the host device that a user is the owner of the license. Alternatively or additionally, in at least some embodiments, this step can also include verifying the ownership of the SEHD to the host device.

As also described above, the license data can include a license for software and/or hardware functionality, and metadata describing an ASU for the functionality. Furthermore, this license data can be securely stored in a secure execution environment implemented on, or otherwise provided by, the SEHD. The functionality, however, can be used on the host device. As such, the license data (including the license) can be decoupled from the host device.

Step 802 provides, for each of one or more time periods, permission to the host device to use functionality based on the license data. In at least some embodiments, such as those described above, this step can include periodically receiving a confirmation signal from the host device while the SEHD is communicatively linked with the host device. For example, the host device may send a confirmation signal confirming that the functionality has been used. In the context of functionality that is software for instance, the confirmation signal may indicate that the software is being executed—thus confirming the use of the software over the preceding authorized period of time. In at least some embodiments, the confirmation signal can function as a challenge/response from the host device to the SEHD to ensure that the SEHD is valid and not an imposter, and that the license is valid and not expired. This can be accomplished in any suitable way. For example, a public/private key exchange between the host device and the SEHD might be used to confirm the validity of the SEHD, and thus the license.

Step 802 can also include, in response to periodically receiving a confirmation signal, providing a periodic authorization signal to the host device. For example, the authorization signal may confirm, by virtue of being sent to the host device, that the SEHD is communicatively linked with the host device and that that the host device has permission to use the functionality. Alternatively or additionally, the authorization may provide data expressly indicating that the host device has permission to use the functionality. The permission can be provided for the one or more time periods until the ASU for the functionality has expired and/or until the use on the host device has stopped. For example, in the context of functionality that is software, the user of the software might cause the execution of the software to terminate.

As noted above, the license data can include metadata describing the ASU. As such, the ASU can be used to determine whether the license (and thus the ASU for the license) is associated with an unlimited scope of usage (e.g., a perpetual license), that will expire on a certain date/time, or is otherwise not to be decremented. In the event the ASU is not to be decremented, permission can be provided for the one or more time periods until the ASU for the functionality has expired and/or until the use on the host device has stopped.

However, in the event that the ASU is to be decremented (e.g., the license is associated with a limited ASU), step 804 incrementally decrements the ASU for each of the individual time periods. As such, the amount of time the functionality was used can be accounted for and the ASU decreased accordingly. As a practical example, consider a license for software that is associated with an ASU of 120 days. As the functionality is used on the host device, the ASU can be incrementally decremented for individual time periods of usage. As a result, the metering can continue such that permission is given to use the software until the 120 days of available usage has been exhausted (as a result of the ASU being incremental decremented). At that point, the license may be deemed expired unless/until the owner of the license supplements/renews the ASU from a licensing entity or other suitable source.

### CONCLUSION

Portable parameter-based licensing techniques are described herein. These techniques allow licenses to be decoupled from any particular host device and utilized in a portable and flexible fashion. In at least some embodiments, license data that includes a license to use computer-related functionality (e.g., a software application, operating system, etc.) can be stored in a secure execution environment. The secure execution environment can be provided by a suitable secure execution environment hosting device(s) (SEHD), such as a portable flash memory device for instance. The license data in the secure execution environment can then be utilized to authorize use of the computer-related functionality, according to the license, on any number of host devices not responsible for providing the secure execution environment. As a result, the owner of the license can use the computer-related functionality without being restricted to any particular host device.

Although techniques, methods, devices, systems, etc., pertaining to portable parameter-based licensing techniques are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. One or more computer-readable storage media embodying computer-executable instructions which, when executed, implement a method comprising:
obtaining license data from a licensing entity;
storing the license data in a secure execution environment, wherein the license data comprises a license for software;
authenticating the secure execution environment with a host device, wherein the secure execution environment is provided by one or more devices other than the host device; and
authorizing a usage of the software on the host device based at least in part on the license data securely stored in the secure execution environment.

2. The one or more computer-readable storage media of claim 1, wherein the obtaining comprises:
authenticating the secure execution environment with the licensing entity;
responsive to the authenticating the secure execution environment with the host device, receiving encrypted license data in the secure execution environment; and
decrypting the encrypted license data to obtain the license data.

3. The one or more computer-readable storage media of claim 1, wherein the method further comprises:
authenticating the secure execution environment with the licensing entity; and
responsive to the authenticating the secure execution environment with the host device, permitting the licensing entity to modify the license data.

4. The one or more computer-readable storage media of claim 1, wherein the authorizing comprises one or more of:
validating that the license permits the usage;
metering the usage; or
exporting a new license for the software to the host device.

5. The one or more computer-readable storage media of claim 4, wherein the metering comprises one or both of:
providing, for each of one or more time periods, permission to the host device to use the software; or
incrementally decrementing, for individual time periods, an available scope of usage of the license.

6. The one or more computer-readable storage media of claim 5, wherein the providing comprises:
periodically receiving a confirmation signal from the host device while the secure execution environment is communicatively linked with the host device; and
responsive to the periodically receiving, periodically providing an authorization signal to the host device for each of the one or more time periods.

7. The one or more computer-readable storage media of claim 4, wherein the exporting comprises:
generating the new license for the software with a new available scope of usage equal to or less than an available scope of usage of the license;
modifying the available scope of usage of the license according to the new available scope of usage; and
supplying the host device with the new license.

8. The one or more computer-readable storage media of claim 1, wherein the one or more devices other than the host device comprise a portable memory device configured to be communicatively linked with the host device.

9. A device comprising:
one or more storage media configured to securely store license data comprising a license to use computer-related functionality; and
a portable licensing module configured to authorize, based on the license data securely stored on the one or more storage media, a usage of the computer-related functionality on a host device configured to be communicatively linked with the device.

10. The device of claim 9, wherein the device comprises a flash memory device configured to be removeably attached to the host device to communicatively link with the host device.

11. The device of claim 9, wherein the computer-related functionality is related to one more of:
a software application;
an operating system;
a software application upgrade; or
an operating system upgrade.

12. The device of claim 9, wherein the portable licensing module is configured to authorize the usage by one or more of:
validating that the license permits the usage;
metering the usage; or
exporting a new license for the computer-related functionality to the host device.

13. The device of claim 12, wherein the metering comprises one or both:
providing, for each of one or more time periods, permission to the host device to use the computer-related functionality; or
incrementally decrementing, for individual time periods, an available scope of usage of the license.

14. The device of claim 12, wherein the exporting comprises:
generating the new license, wherein the new license is associated with a new available scope of usage equal to or less than an available scope of usage of the license;
decrementing the available scope of usage of the license according to the new available scope of usage; and
supplying the host device with the new license.

15. The device of claim 9, wherein the portable licensing module is configured to obtain the license data by:
authenticating the device with a licensing entity;
responsive to the authenticating, receiving encrypted license data; and
decrypting the encrypted license data to obtain the license data.

16. One or more computer-readable storage media embodying computer-executable instructions which, when executed, implement a method comprising:
authenticating license data of a first device to a second device, wherein the license data describes an available scope of usage for software and is securely stored on the first device; and
for each of one or more time periods, providing permission to the second device to use the software based at least in part on the license data.

17. The one or more computer-readable storage media of claim 16, wherein the providing permission comprises:
periodically receiving a confirmation signal from the second device while the first device is communicatively linked with the second device; and
responsive to the periodically receiving, periodically providing an authorization signal to the second device.

18. The one or more computer-readable storage media of claim 16, wherein the method further comprises incrementally decrementing, for each of the one or more time periods, the available scope of usage.

19. The one or more computer-readable storage media of claim 16, wherein the available scope of usage is defined by one or more of:
time increments of available software usage;
available software feature levels; or
one or more pre-defined usage tracking units.

20. The one or more computer-readable storage media of claim 16, wherein the first device comprises a portable memory device configured to be removeably attached to the second device to communicatively link with the second device.
